(19) United States
(12) Patent Application Publication
(10) Pub. No.: US 2005/0196673 A1
(43) Pub. Date: Sep. 8, 2005

(54) Electrochemically active material for the positive electrode of a lithium rechargeable electrochemical cell

(75) Inventors: Philippe Biensan, Carignan de Bordeaux (FR); Christian Jordy, St. Louis De Montferrand (FR); Jean-Pierre Boeuve, Montussan (FR)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/017,707

(22) Filed: Dec. 22, 2004

(30) Foreign Application Priority Data
Dec. 23, 2003 (FR) 0315225

(51) Int. Cl. H01M 4/52; H01M 4/58; H01M 4/40

(52) U.S. Cl. 429/231.1; 429/223; 429/231.6; 429/220; 429/221; 429/231.3; 429/231.5; 429/231.95; 429/231.4

(57) ABSTRACT

The present invention provides a lithium rechargeable electrochemical cell containing a liquid electrolyte and an electrochemically active material for the positive electrode, wherein said active material comprises a mixture of: I) a composite oxide of lithium and at least one transition metal selected from Ni and Co, which is also substituted by an element selected from Mg, Al, B, Ti, Si, Zr, Fe, Zn, and Cu; and
II) a composite oxide of phosphorus, lithium, and at least one transition metal of general formula LiₜM²_{z}PO₄ where 0<t<3 and z=1 or 2, and such that the content of the composite oxide of phosphorus, lithium, and at least one transition metal lies in the range 1% to 50% of the weight of said mixture.

The present invention relates to an electrochemically active material for use in the positive electrode of a lithium rechargeable electrochemical cell. Naturally, the invention also relates to a positive electrode containing such an active material, and to a lithium cell containing such an electrode.

### BACKGROUND OF THE INVENTION

The lithium-containing oxides of transition metals are known as constituting cathode active material that is suitable for use in lithium rechargeable cells. In the positive electrode or cathode, the active material most commonly used comprises lithium-containing oxides of transition metals having the general formula LiₓM_{y}Oₜ, where M is usually Mn, Ni, or Co, and substituted derivatives thereof. Such active materials enable high performance to be obtained, in particular in terms of reversible cycling capacity and lifetime. The active materials constituting the positive electrodes of the cells presently in use have thermal stability that satisfies various tests performed under so-called “abusive” conditions, such as the nail test and the external short-circuit test. Nevertheless, violent reactions occur, and in particular flames are given off, when performing the tests that stimulate a failure of the charger system, whereby the cell is overcharged at a charging rate of Ic (where Ic is the current theoretically needed to discharge the cell in one hour).

Other types of active material of lower cost have also been studied, including the lithium-containing phosphates of transition metals, in particular compounds based on LiFePO₄. Nevertheless, the use of such compounds comes up against their poor capacity, their poor electron conductivity, and the fact that LiFePO₄ and FePO₄ are poor ion conductors. The electrode therefore needs to have added thereto a large concentration of conductive material, thereby penalizing its performance, in particular its cycling characteristics. Studies for the purpose of mitigating this drawback have paid particular attention to improving the methods of synthesizing such compounds.

### OBJECTS AND SUMMARY OF THE INVENTION

An object of the present invention is to propose an electrochemically active material for the positive electrode of a lithium rechargeable electrochemical cell suitable for preventing flames occurring when performing abusive overcharge tests on the cell.

The present invention provides a lithium rechargeable electrochemical cell containing a liquid electrolyte and an electrochemically active material for the positive electrode, wherein said active material comprises a mixture of:
I) a composite oxide of lithium and at least one transition metal selected from Ni and Co, which is also substituted by an element selected from Mg, Al, B, Ti, Si, Zr, Fe, Zn, and Cu; and
II) a composite oxide of phosphorus, lithium, and at least one transition metal of general formula LiₜM²_{z}PO₄ where 0<t<3 and z=1 or 2, and such that the content of the composite oxide of phosphorus, lithium, and at least one transition metal lies in the range 1% to 50% of the weight of said mixture.

Cells having a positive electrode based on an active material of the type comprising a lithium-containing oxide of a substituted transition metal react violently during overcharging because a very large quantity of gas is generated in association with high gas temperatures. During abusive overcharge testing, the gas escapes very quickly and given the temperature at which the gas escapes, the gas ignites automatically on coming into contact with the atmosphere, whence the presence of flames.

Active materials based on phosphates are known to react little under overcharging conditions. Nevertheless, their small specific capacity, their very low conductivity, and their low operating voltage means that such materials present little interest.

The novel technical solutions recommended by the invention for solving the difficulties of the prior art and the drawbacks specified above rely on using a mixture of an active material having high reversible capacity with an active material based on phosphate which presents low conductivity.

By using a mixture of these materials, the Applicant expected that the maximum temperature reached by the electrochemical cell during thermal runaway on overcharging would be reduced. That effect was not observed. In contrast, the Applicant discovered a surprising phenomenon which consists in a much smaller quantity of flammable gas being generated than would normally have been expected. In addition, the storage cell was observed to present an internal resistance that was much lower than that expected.

Preferably the quantity of the composite oxide of phosphorus, lithium, and at least one transition metal lies in the range 1% to 30% of the weight of said mixture, and more preferably, the content of the composite oxide of phosphorus, lithium, and at least one transition metal lies in the range 5% to 30% of the weight of said mixture.

M² is preferably at least one element selected from Fe, Ni, Co, Mn, and V. More preferably, M² is Fe.

In a variant, M² is substituted by an element selected from Mg, Al, B, Ti, Si, Zr, Fe, Zn, and Cu.

Said composite oxide of phosphorus, lithium, and a transition metal is preferably selected from LiFePO₄, LiVPO₄F, and Li₃Fe₂PO₄. The composite oxide of phosphorus, lithium, and a transition metal may optionally be at least partially substituted by another element.

The present invention also describes a positive electrode for a lithium rechargeable electrochemical cell containing the above-described active material. The electrode is constituted by a conductive support acting as a current collector which is coated in a layer containing the electrochemically active material of the invention and further comprising a binder and a conductive material.

The current collector is preferably a two-dimensional conductive support such as a solid or perforated foil, based on carbon or a metal, e.g. copper, nickel, steel, stainless steel, or aluminum. Preferably, a positive electrode includes an aluminum collector. In the event of the storage cell being overdischarged or reversed, this avoids short-circuiting via copper dendrites that will occur if the collector were made of copper.

The binder may contain one or more of the following components: polyvinylidene fluoride (PVdF) and copolymers thereof, polytetrafluroethylene (PTFE), polyacrylonitrile (PAN), polymethyl or polybutyl methacrylate, polyvinyl chloride (PVC), polyvinylformal, amine block polyethers and polyesters, acrylic acid polymers, methacrylic acid, acrylamide, itakonic acid, sulfonic acid, elastomers, and cellulose compounds.

Amongst the elastomers that are suitable for use, mention can be made of ethylene/propylene/diene terpolymers (EPDM), styrene/butadiene copolymers (SBR), acrylonitrile/butadiene copolymers (NBR), styrene/butadiene/styrene block copolymers (SBS) or styrene/acrylonitrile/styrene block copolymers (SIS), styrene/ethylene/butylene/styrene copolymers (SEBS), styrene/butadiene/vinylpyridine terpolymers (SBVR), polyurethanes (PU), neoprenes, polyisobutylenes (PIB), butyl rubbers, etc. . . . , and mixtures thereof.

The cellulose compound may be a carboxymethylcellulose (CMC), a hydroxypropylmethylcellulose (HPMC), a hydroxypropylcellulose (HPC), or a hydroxyethylcellulose (HEC).

The conductive material is selected from graphite, carbon black, acetylene black (AB), soot, and a mixture thereof.

The present invention also provides a lithium rechargeable electrochemical cell having a positive electrode containing an active material as described above. The cell of the invention further comprises a negative electrode, a separator, and a liquid electrolyte.

The negative electrode is constituted by a conductive support acting as a current collector which is coated in a layer containing the electrochemically active material and further comprising a binder and a conductive material, and its collector is made of copper or of nickel; advantageously, the negative collector is made of copper. The electrochemically active material is selected from metallic lithium, lithium alloys, a carbon-containing material capable of inserting lithium into its structure, such as graphite, coke, carbon black, and vitreous carbon, and a composite oxide of lithium and a transition metal such as nickel, cobalt, or titanium.

The electrolyte is a non-aqueous liquid electrolyte comprising a lithium salt dissolved in a solvent.

The lithium salt is selected from lithium perchlorate LiClO₄, lithium hexafluoroarsenate LiAsF₆, lithium hexafluorophosphate LiPF₆, lithium tetrafluoroborate LiBF₄, lithium trifluoromethanesulfonate LiCF₃SO₃, lithium trifluoromethanesulfonimide LiN(CF₃SO₂)₂ (LiTFSl), lithium trifluoromethanesulfonemethide LiC(CF₃SO₂)₃ (LiTFSM), lithium bisperfluoroethylsulfonimide LiN(C₂F₅SO₂)₂ (BETI), and mixtures thereof.

Preferably, the solvent is a solvent or a mixture of solvents selected from the usual organic solvents, in particular saturated cyclical carbonates, unsaturated cyclical carbonates, non-cyclical carbonates, alkyl esters, such as formiates, acetates, propionates, or butyrates, ethers, lactones such as □-butyrolactone, tetrahydrothiofene dioxide (sold under trademark “SULFOLANE”), nitril solvents, and mixtures thereof. Amongst saturated cyclic carbonates, mention can be made for example of ethylene carbonate (EC), propylene carbonate (PC), butylene carbonate (BC), and mixtures thereof. Amongst unsaturated cyclic carbonates, mention can be made for example of vinylene carbonate (VC), its derivatives, and mixtures thereof. Amongst non-cyclic carbonates, mention can be made for example of dimethyl carbonate (DMC), diethyl carbonate (DEC), ethyl methyl carbonate (EMC), dipropyl carbonate (DPC), and mixtures thereof. Amongst alkyl esters, mention can be made for example of methyl acetate, ethyl acetate, methyl propionate, ethyl propionate, butyl propionate, methyl butyrate, ethyl butyrate, propyl butyrate, and mixtures thereof. Amongst ethers, mention can be made for example of dimethyl ether (DME) or diethyl ether (DEE), and mixtures thereof. Mention can also be made of 1,2-dimethoxyethane, 1,2-diethoxyethane, 2-methyl tetrahydrofurane, and 3-methyl-1,3-dioxolane.

### BRIEF DESCRIPTION OF THE DRAWINGS

Other characteristics and advantages of the present invention appear from the following examples, given naturally by way of non-limiting illustration, and from the accompanying drawing, in which:

FIG. 1 is a diagrammatic section through a button-format electrochemical cell;

FIG. 2 shows charging and discharge curves at Ic/20 for an electrochemical cell whose positive electrode contains a prior art active material, the cell voltage being plotted up the ordinate, and its capacity in milliampere hours per gram (mAh/g) being plotted along the abscissa;

FIG. 3, analogous to FIG. 2, plots charging and discharging curves at Ic/20 for an electrochemical cell whose positive electrode contains an active material of the invention; and

FIG. 4 is a diagrammatic section of an electrochemical cell of cylindrical format with spiral-wound electrodes.

### MORE DETAILED DESCRIPTION

Preparing an Electrode

A positive electrode was prepared as follows. A paste was prepared by mixing 86% by weight of the electrochemically active material, 6% by weight of a binder, preferably polyvinylidene fluoride (PVdF), and 8% by weight of a carbon-containing conductive material, preferably a mixture made up of 4% soot and 4% graphite. The viscosity of the paste was adjusted using N-methylpyrolidone (NMP). The resulting paste was deposited on an aluminum foil which served as the conductive support for the electrode. The electrode was then dried at 140° C. for 1 hour (h), and then calendared.

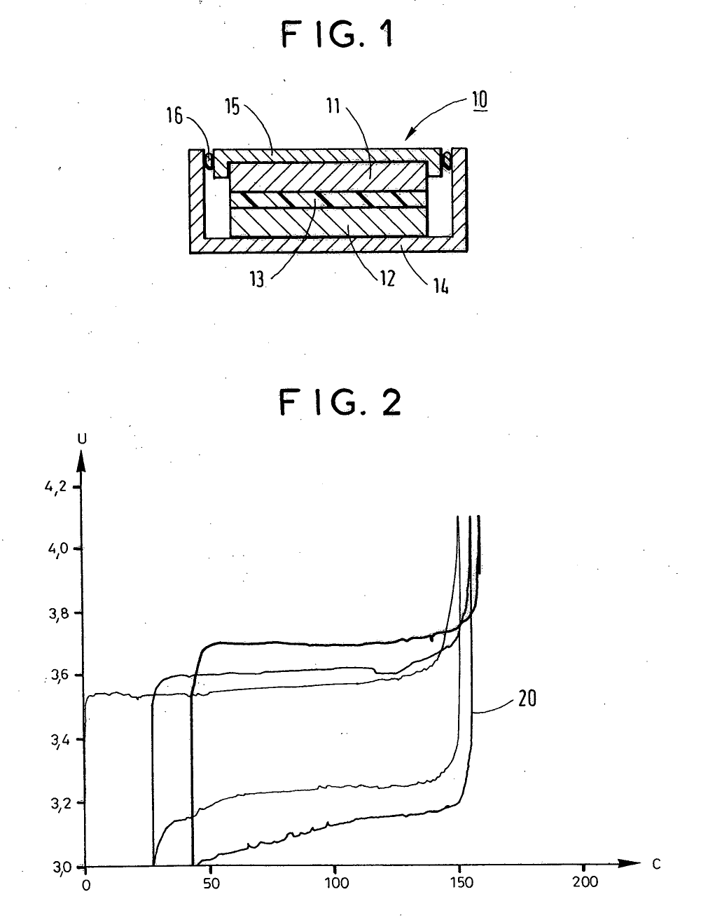

The previously prepared electrode was used to make two types of cell:
a button-format rechargeable electrochemical cell (FIG. 1) having a negative electrode made of metallic lithium, for the purpose of evaluating the electrochemical capacity of the active material of the positive electrode; and
a 4/5A format cylindrical rechargeable electrochemical cell (FIG. 4) including a negative electrode constituted mainly of graphite, in order to characterize thermal behavior during abusive overcharge testing of the cell.

Evaluating Electrochemical Capacity

A button-format electrochemical cell 10 is shown in FIG. 1. It comprises a positive electrode 11 facing a negative electrode 12 constituted by a sheet of metallic lithium. The positive and negative electrodes 11 and 12 are on opposite sides of a separator 13 constituted by a membrane of polyethylene (PE) sold by the supplier “CELANESE” under the name “CELGARD”. The electrochemical couple obtained in this way was placed in a cup 14 closed in sealed manner by a cover 15 via a gasket 16. The electrochemical couple was impregnated in an electrolyte comprising a mixture of propylene carbonate, ethylene carbonate, and dimethyl carbonate (PC/EC/DMC) in volume proportions of 1:1:3; and containing a lithium salt which was lithium hexafluorophosphate LiPF₆ at 1 molar (M) concentration. The cell was assembled and filled with electrolyte in a glove box under a moisture-free argon atmosphere.

The reversible capacities of the active materials forming part of the invention and those of active materials forming part of the prior art were measured using a button-format cell charging at a rate of Ic/20, where Ic is the current theoretically required for discharging the cell in one hour.

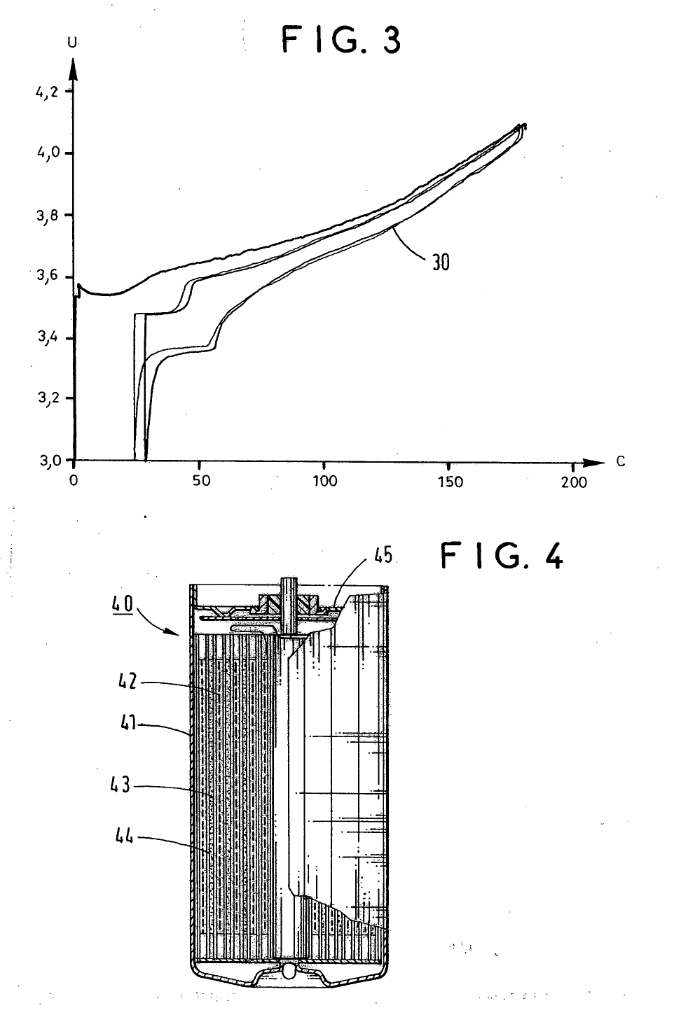

FIG. 2 plots a curve 20 corresponding to three charges and two discharges in succession at Ic/20 for an electrochemical cell whose positive electrode contains a prior art active material LiFePO₄. Similarly, FIG. 3 plots a curve 30 of three charges and two discharges in succession at Ic/20 for an electrochemical cell whose positive electrode contains an active material of the invention comprising 80% LiNi_{0.80}Co_{0.15}Al_{0.05}O₂+20% LiFePO₄.

The results obtained are summarized in Table 1 below.

TABLE 1

| | Reversible | Reversible | Polarization (voltage |
|---|---|---|---|
| | capacity at | capacity at | difference between |
| | Ic/20 | Ic/10 | charging and |
| Active material | (mAh/g) | (mAh/g) | discharging at Ic/20) |
| 100% LiFePO₄ | 125 | 25 | 350 mV to 550 mV |
| (prior art) | | | |
| 100% | 160 | 160 | <20 mV |
| LiNi_{0.80}Co_{0.15}Al_{0.05}O₂ | | | |
| (prior art) | | | |
| 80% | 155 | 155 | <120 mV |
| LiNi_{0.80}Co_{0.15}Al_{0.05}O₂ + | | | |
| 20% LiFePo₄ (invention) | | | |

Very high polarization (voltage difference between charging and discharging, corresponding to very high internal resistance) was observed on the composite oxide of phosphorus and iron LiFePO₄ (>350 mV), thus leading to a very high loss of reversible capacity, in particular at a rate of Ic/10. In contrast, with the material constituting a composite oxide of lithium and transition metals LiNi_{0.80}Co_{0.15}Al_{0.05}O₂, the reversible capacity did not change with charging rate.

Given the above results, the capacity to be expected for the material of the invention at a rate of Ic/10 was 130 mAh/g. However the value that was actually measured is much better: it is 155 mAh/g.

Thermal Behavior During Abusive Overcharge Testing

An evaluation was made of the ability to withstand overcharging of a lithium rechargeable cell including a positive electrode containing an active material of the invention made up of a mixture of 80% by weight of a composite oxide of lithium, nickel, and cobalt substituted with aluminum LiNi_{0.80}Co_{0.15}Al_{0.05}O₂ and 20% by weight of a composite oxide of phosphorus, lithium, and iron LiFePO₄. By way of comparison, the ability of a lithium rechargeable cell having a positive electrode containing a prior art active material to withstand overcharging was also evaluated.

FIG. 4 is a section through a cylindrical cell 40 comprising a container 41 containing a spiral-wound electrochemical stack made up of a positive electrode 42 and a negative electrode 43 on either side of a separator 44. The negative electrode was constituted by an active layer containing graphite as the active material and a binder constituted by 2% SBR and 2% CMC deposited on a copper foil. The negative electrode was designed in such a manner that the ratio of the capacity of the negative electrode compared with the capacity of the positive electrode was about 1:3. Once the electrochemical stack and the electrolyte had been inserted in the container 41, the cell was closed hermetically by a cover 45.

The 4/5A format cylindrical electrochemical cell was placed in a leaktight enclosure of calibrated volume (1 liter) fitted with a pressure sensor. Overcharge testing was performed under an inert atmosphere (argon or nitrogen) after the cell had previously been charged. The overcharging rate used was 2 Ic. After overcharging for about 30 minutes, thermal runway of the storage cell was observed.

The results obtained for an active material of the invention and for an active material of the prior art are summarized in Table 2 below. Because of the very high impedance of the prior art active material LiFePO₄, it was not possible to perform overcharging.

TABLE 2

| Active material | Quantity of gas generated (bar.liter) |
|---|---|
| 100% LiNi_{0.80}Co_{0.15}Al_{0.05}O₂ | 4 |
| (prior art) | |
| 80% LiNi_{0.80}Co_{0.15}Al_{0.05}O₂ + | 2.4 |
| 20% LiFePO₄ | |
| (invention) | |

The use of an active material of the invention in a lithium cell makes it possible to divide the total quantity of gas given off by about 2 compared with a prior art cell. In addition, the energy measured on the cells remains very high. These characteristics mean that electrochemical cells containing the active material of the invention are particularly advantageous, in particular from the points of view of performance and safety.

Naturally, the present invention is not limited to the embodiments described, and the invention can be varied in numerous ways within the competence of the person skilled in the art without going beyond the spirit of the invention. In particular, without going beyond the ambit of the invention, it is possible to envisage using a conductive support for the electrode of different nature and structure. Finally, the various ingredients used for making the paste, and their relative proportions could be changed. In particular, additives for facilitating electrode forming, such as a textured stabilizer or thickener could be incorporated therein.

1. A lithium rechargeable electrochemical cell containing a liquid electrolyte and an electrochemically active material for the positive electrode, wherein said active material comprises a mixture of:
I) a composite oxide of lithium and at least one transition metal selected from Ni and Co, which is also substituted by an element selected from Mg, Al, B, Ti, Si, Zr, Fe, Zn, and Cu; and
II) a composite oxide of phosphorus, lithium, and at least one transition metal of general formula LiₜM²_{z}PO₄ where 0<t<3 and z=1 or 2, and such that the content of the composite oxide of phosphorus, lithium, and at least one transition metal lies in the range 1% to 50% of the weight of said mixture.

2. A cell according to claim 1, in which the content of the composite oxide of phosphorus, lithium, and at least one transition metal lies in the range 1% to 30% by weight of said mixture.

3. A cell according to claim 1, in which the content of the composite oxide of phosphorus, lithium, and at least one transition metal lies in the range 5% to 30% by weight of said mixture.

4. A cell according to claim 1, in which the transition metal of the composite oxide of lithium is substituted by Al.

5. A cell according to claim 4, in which the composite oxide of lithium and at least one transition metal has the formula LiNi_{0.80}Co_{0.15}Al_{0.05}O₂.

6. A cell according to claim 1, in which M² is at least one element selected from Fe, Ni, Co, Mn, and V.

7. A cell according to claim 6, in which M² is Fe.

8. A cell according to claim 1, in which M² is substituted by an element selected from Mg, Al, B, Ti, Si, Zr, Fe, Zn, and Cu.

9. A cell according to claim 1, in which said composite oxide of phosphorus, lithium, and a transition metal is preferably selected from LiFePO₄, LiVPO₄F, and Li₃Fe₂PO₄, and may be at least partially substituted.

10. A lithium rechargeable electrochemical cell containing a liquid electrolyte and an electrochemically active material for the positive electrode, wherein said active material comprises a mixture of:
I) a composite oxide of lithium and at least one transition metal selected from Ni and Co, which is also substituted by Al; and
II) a composite oxide of phosphorus, lithium, and at least one transition metal of general formula LiₜM²₄PO₄ where 0<t<3 and z=1 or 2, in which M² is at least one element selected from Fe, Ni, Co, Mn and V;
and such that the content of the composite oxide of phosphorus, lithium, and at least one transition metal lies in the range 5% to 30% of the weight of said mixture.

11. A cell according to claim 1, in which the positive electrode further comprises a binder and a conductive material.

12. A cell according to claim 11, further comprising a negative electrode and a separator.

13. A cell according to claim 1, in which said negative electrode contains an electrochemically active material selected from metallic lithium, lithium alloys, a carbon-containing material capable of inserting lithium in its structure, and a composite oxide of lithium and a transition metal.

14. A cell according to claim 13, in which said carbon-containing material is selected from graphite, coke, carbon black, and vitreous carbon.

15. A cell according to claim 1, in which said electrolyte is selected from a non-aqueous liquid electrolyte comprising a lithium salt dissolved in a solvent.
